(19) United States
(12) Patent Application Publication
(10) Pub. No.: US 2015/0328736 A1
(43) Pub. Date: Nov. 19, 2015

(54) Hand-Guided Semiautonomous Jigsaw

(71) Applicant: Robert Bosch GmbH, Stuttgart (DE)

(72) Inventors: Nicolas Klotz, Niefern-Oeschelbronn (DE); Ulli Hoffmann, Niefern-Oeschelbronn (DE); Andre Hoffmann, Riedholz (CH); Marcel Fankhauser, Bern (CH)

(21) Appl. No.: 14/711,037

(22) Filed: May 13, 2015

(30) Foreign Application Priority Data
May 13, 2014 (DE) 10 2014 209 011.3

(51) Int. Cl. B23Q 15/14; B23D 59/00; B23D 49/16

(52) U.S. Cl. CPC B23Q 15/14; B23D 49/162; B23D 59/001

(57) ABSTRACT

A hand-guided semiautonomous jigsaw includes a tool receiver and an electronic control unit. The tool receiver is configured to receive a saw blade having a cutting edge for sawing along a predefined reference cutting line on an assigned workpiece. An electromechanical actuator is configured to swivel the tool receiver within a predefined angular range about a swivel axis coincident with a rotation axis of the saw blade in response to a signal from an assigned optoelectronic mechanism in order to automatically align the saw blade when sawing along the predefined reference cutting line. The electronic control unit is configured to compensate a parallel distance between the cutting edge and the rotation axis of the saw blade during sawing.

This application claims priority under 35 U.S.C. §119 to patent application no. DE 10 2014 209 011.3, filed on May 13, 2014 in Germany, the disclosure of which is incorporated herein by reference in its entirety.

The present disclosure relates to a hand-guided semiautonomous jigsaw, comprising a tool receiver, which can accommodate within it a saw blade that has a cutting edge for the purpose of sawing along a predefined reference cutting line on an assigned workpiece, the tool receiver being such that it can be swiveled within a predefined angular range about a swivel axis that is coincident with a rotation axis of the saw blade, by means of an electromechanical actuator means, in response to a signal, supplied by an assigned optoelectronic means, for automatically aligning the saw blade during sawing.

### BACKGROUND

Such a hand-guided semiautonomous jigsaw, having an assigned tool receiver for a saw blade, is known from the prior art. The tool receiver is designed such that it can be swiveled about its vertical axis by means of a suitable actuator means. The actuator means is driven, for example, by the use of signals of an optoelectronic means, which senses with precision the course of a marking line that is pre-drawn on an assigned workpiece and that represents a reference cutting line. As a result, the saw blade can always swivel in a semiautonomous manner, i.e. automatically, about its vertical, or rotation, axis, according to the course of the marking line, such that a corresponding saw cut can be effected more easily and with greater precision, even by an inexperienced user.

A disadvantage of the prior art is that a distance, between a cutting edge and a rotation axis of the saw blade, that is dependent on the saw blade type, and/or a respective sawing speed may result in unwanted deviations between the reference cutting line pre-drawn on the workpiece and a respectively produced saw cut, or kerf.

### SUMMARY

It is therefore an object of the disclosure to provide a new semiautonomous jigsaw, with which deviations between the reference cutting line and the kerf, resulting from differing distances between a rotation axis and a cutting edge of a respective saw blade, are at least reduced.

This problem is solved by a hand-guided semiautonomous jigsaw, comprising a tool receiver, which can accommodate within it a saw blade that has a cutting edge for the purpose of sawing along a predefined reference cutting line on an assigned workpiece, the tool receiver being such that it can be swiveled within a predefined angular range about a swivel axis that is coincident with a rotation axis of the saw blade, by means of an electromechanical actuator means, in response to a signal, supplied by an assigned optoelectronic means, for automatically aligning the saw blade during sawing. An electronic control unit is provided, which is designed to compensate a parallel distance between the cutting edge and the rotation axis of the saw blade during sawing.

The disclosure thus makes it possible to provide a hand-guided semiautonomous jigsaw with which deviations between a respective saw cut and the predefined reference cutting line, and therefore an occurrence of cut errors, are at least reduced. The term “cut error” in this case defines any deviation between the reference cutting line predefined by the user and a kerf produced by the saw blade.

According to an embodiment, the electronic control unit is designed to compensate the parallel distance between the cutting edge and the rotation axis of the saw blade by shifting a respective point of origin of a signal processing of the signal supplied by the assigned optoelectronic means.

This enables the parallel distance to be compensated in a simple manner. The compensation required for the respective saw blade type is effected for the case that the optoelectronic means is, for example, an imaging electronic camera, specifically by appropriately displacing, or shifting, the point of origin, or the starting point, for the signal processing in the camera image, i.e. in the signal supplied by the optoelectronic means, in a positive or a negative direction. Moreover, a sawing speed, i.e. the effective rate of advance of the saw blade in a workpiece, can preferably likewise be determined by means of the optoelectronic means.

According to an embodiment, the respective point of origin of the signal processing can be shifted in or contrary to a sawing direction.

Consequently, parallel distances resulting from differing saw blade types can thus also be prevented in a positive and reliable manner.

Preferably, the electronic control unit is designed to compensate the parallel distance between the cutting edge and the rotation axis of the saw blade in dependence on differing saw blade types and/or sawing speeds.

Deviations between a respective saw cut and the predefined reference cutting line, and consequently an occurrence of cut errors resulting from differing saw blade types and/or sawing speeds, can thus be at least reduced in a simple manner.

According to an embodiment, a respective saw blade type can be sensed by the optoelectronic means, or can be input via an appropriate input means.

A respective saw blade type can thus be determined positively and reliably in a user-friendly and convenient manner. Saw blade types in the context of this description may be, for example, ceramic saw blades, metal saw blades, hardwood high-speed saw blades or (soft-) wood saw blades.

Preferably, the saw blade is accommodated in the tool receiver by means of a fastening portion, the fastening portion being designed so as to be symmetrical in relation to the rotation axis.

This enables a multiplicity of differing saw blade types to be clamped in the tool receiver.

Preferably, at least the parallel distance can be sensed by means of the optoelectronic means.

This enables the parallel distance to be sensed in a particularly convenient and, if appropriate, automatic manner.

According to an embodiment, at least the parallel distance can be sensed by means of a sensor.

This enables the parallel distance to be determined independently of the optoelectronic means.

According to an embodiment, at least the parallel distance is stored in the electronic control unit, for the purpose of selection and confirmation by the user.

This make is possible to reduce the effort required to sense the parallel distance by measurement means.

According to an embodiment, the parallel distance can be set manually by a user, by means of a control element.

This makes it possible to realize setting of the parallel distance, for the purpose of optimizing the sawing result, that is particularly simple in design.

Preferably a marking is provided, in particular in the region of a foot plate of the jigsaw, which marking aids the user in setting the parallel distance by means of the control element.

The marking facilitates the manual definition of the parallel distance for the purpose of achieving accurate sawing results.

According to an embodiment, a respective sawing speed can be measured by means of the optoelectronic means and/or by means of a sensor.

It is thus made possible for the sawing speed to be sensed in a convenient and user-friendly manner.

Preferably, when in operation, the saw blade, in addition to executing its swivel motion, also executes at least a vertically oscillating stroke motion.

As in the case of each jigsaw known from the prior art, this provides a normal sawing operation. If appropriate, a pendulum motion may also be superposed on the stroke motion, in order to increase the cutting, or sawing, performance.

Furthermore, the problem is also solved by a method for automatically aligning a saw blade accommodated in a tool receiver of a hand-guided semiautonomous jigsaw. The saw blade has a cutting edge for the purpose of sawing along a predefined reference cutting line on an assigned workpiece. The tool receiver is such that it can be swiveled within a predefined angular range about a swivel axis that is coincident with a rotation axis of the saw blade, by means of an electromechanical actuator means, in response to a signal, supplied by an assigned optoelectronic means, for automatically aligning the saw blade when sawing along the predefined reference cutting line. A parallel distance between the cutting edge and the rotation axis of the saw blade is compensated by an electronic control unit of the jigsaw.

This ensures that a respective kerf, or saw cut, to be executed always precisely follows the reference cutting line predefined by the user, and consequently at least improved working results can be achieved.

### BRIEF DESCRIPTION OF THE DRAWINGS

The disclosure is explained in greater detail in the following description, on the basis of exemplary embodiments represented in the drawings. In the drawings:

FIG. 1 shows a perspective view of jigsaw realized in the manner of a hand-guided semiautonomous jigsaw, having a saw blade,

FIG. 2 shows a schematic top view of a workpiece to be sawn by means of the saw blade of FIG. 1, a rotation axis, or a rotation point, of the saw blade being identical with a point of origin of a signal processing,

FIG. 3 shows a schematic top view of the workpiece of FIG. 2, with a positive offset between the rotation axis, or the rotation point, of the saw blade and the point of origin of the signal processing,

FIG. 4 shows a schematic top view of the workpiece of FIG. 2, with a negative offset between the rotation axis, or the rotation point, of the saw blade and the point of origin of the signal processing, and

FIG. 5 shows a top view of four differing types of saw blade (saw blade types), each having a different distance between a cutting edge and a rotation axis.

### DETAILED DESCRIPTION

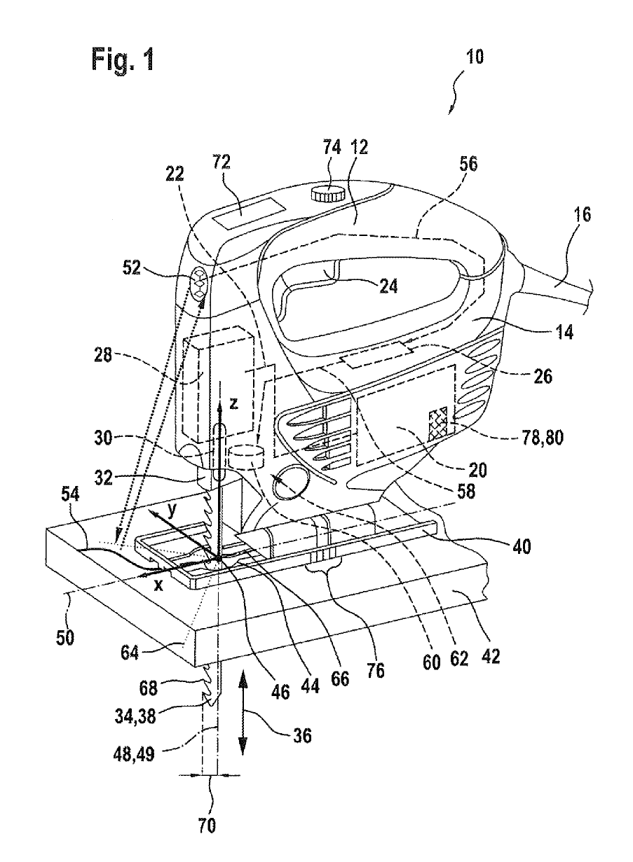

FIG. 1 shows a hand-guided semiautonomous jigsaw 10 according to one embodiment, which has a tool housing 14 provided with a handle 12 that is realized, exemplarily, in the manner of hoop. The hand-guided semiautonomous jigsaw 10 is preferably equipped with a flexible electric connection line 16, for the purpose of supplying mains power.

It must be pointed out, however, that the present disclosure is not to be regarded as being limited to a hand-guided semiautonomous jigsaw 10 that can be operated from mains power but, rather, can also be applied in the case of jigsaws of all types that can be operated independently of mains power, which can be connected, e.g. mechanically and electrically, to an assigned battery pack for the purpose of supplying power.

Moreover, it is pointed out that the present disclosure is also not limited to jigsaws having tool housings that constitute hoop-type handles, but may also be applied, for example, in the case of jigsaws having rod-type tool housings. Furthermore, it is pointed out that, for the purpose of simplicity and conciseness of the description, the hand-guided semiautonomous jigsaw 10 is referred to in the following merely as the “jigsaw 10”.

Exemplarily, a drive motor 20, for driving a drive shaft 22, is disposed in the tool housing 14. The drive motor 20 can be actuated by a user, i.e. at least switched on and off, by means of a hand switch 24, or a hand pushbutton, and may be any type of motor, e.g. an electronically commutated motor or a direct-current motor. Preferably, the drive motor 20 can be electronically controlled by open-loop or closed-loop control by means of an electronic control unit 26, in such a manner that, for example, selections in respect of a desired rotational speed of the drive shaft 22 can be realized. This makes it possible, inter alia, for a respective rotational speed of the drive motor 20 and, associated therewith, a corresponding sawing speed, or a rate of advance of the saw blade 10, to be easily adapted to differing workpiece properties. The principle of functioning and the structure of such a drive motor 20 and of the electronic control unit 26 are sufficiently well known to persons skilled in the art, such that, for conciseness of the description, they are not described in detail here.

The drive shaft 22 of the drive motor 20 is preferably mechanically coupled to a stroke mechanism 28 for driving a stroke unit 30. Exemplarily, the stroke unit 30 has a preferably universal tool receiver 32 for fixedly clamping-in an insert tool 34. The tool receiver 32 with the insert tool 34 clamped therein can be driven with a stroke motion, by means of the stroke mechanism 28, in the direction of a double arrow 36.

Here, the insert tool 34 is realized, merely exemplarily, as a saw blade 38 having a multiplicity of optionally offset saw teeth. The saw blade 38 in this case is perpendicular to a foot plate 40, which is fixed to the tool housing 14 and which rests on an exemplarily flat workpiece 42, or can be guided on the latter. Illustratively in this case the saw blade 38, starting from the tool receiver 32, extends through an opening 44 provided in the foot plate 40, on to the workpiece 42.

Illustratively the tool receiver 32 has a swivel axis 48, which, exemplarily, is coincident with a z-axis of a coordinate system 46 and with a rotation axis 49 of the saw blade 38, while an x-axis of the coordinate system 46, illustratively, is parallel to a longitudinal axis 50 of the jigsaw 10, or of the tool housing 14. Moreover, differing from the shown perpendicular alignment of the saw blade 38 in relation to the workpiece 42, the foot plate 40 may be set to an angle in relation to the z-axis that is other than 90°, for example in order that inclined saw cuts can also be realized in a simple manner.

Integrated into the tool housing 14, exemplarily above the stroke mechanism 28, there is an optoelectronic means 52, by means of which a course of a reference cutting line 54 pre-drawn the workpiece 42 can be sensed with high precision in a contactless manner, for example by means of an optical scanning system such as, for example, an imaging electronic digital camera, that is disposed on the front side. A signal 56 generated by the optoelectronic means 52 is preferably supplied at least to the electronic control unit 26. In this preferably digital control unit 26, signal processing of the signal 56 originating from the optoelectronic means 52 is performed to produce an output signal 58, which is preferably suitable for directly driving a positioning motor 60 of an electromechanical actuator means 62.

The electromechanical actuator means 62 and the positioning motor 60 are in turn mechanically coupled to the tool receiver 32, such that the latter, together with the saw blade 38 clamped therein, can be swiveled, under the control of the control unit 26, about the swivel axis 48, or the rotation axis 49, of the saw blade 38, in an angular range 64. This enables the saw blade 38 to be continuously guided with high precision, in semiautonomous sawing mode, to the course of the pre-drawn reference cutting line 54, in each case in dependence on the signal 56 of the optoelectronic means 52, such that a kerf 66 produced in the workpiece 42 by means of the jigsaw 10 always corresponds with high precision to the predefined course of the reference cutting line 54. As a result, the kerf 66 can be made in the workpiece 42 with a high degree of accuracy, or dimensional consistency, even by inexperienced users.

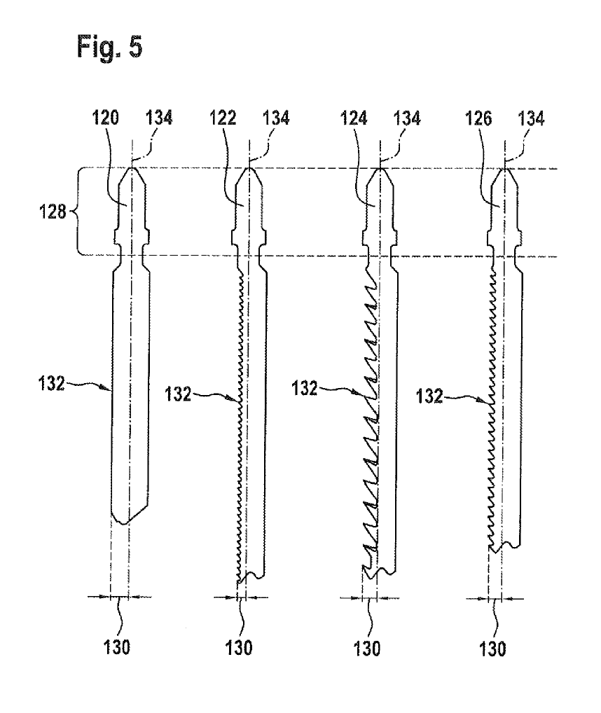

Various saw blade types, such as, for example, ceramic saw blades, metal saw blades, hardwood high-speed saw blades or (soft-) wood saw blades may be used as a saw blade 38 (cf. FIG. 5). Between a cutting edge 68 of the saw blade 38 and the rotation axis 49 of the saw blade 38, or the swivel axis 48 of the tool receiver 32, there is normally a parallel distance 70, which is contingent upon design and which depends, in particular, on the type of the saw blade 38, or the saw blade type. This distance 70 results in unwanted deviations between the ideal reference cutting line 54 and the kerf 66, or in sawing errors.

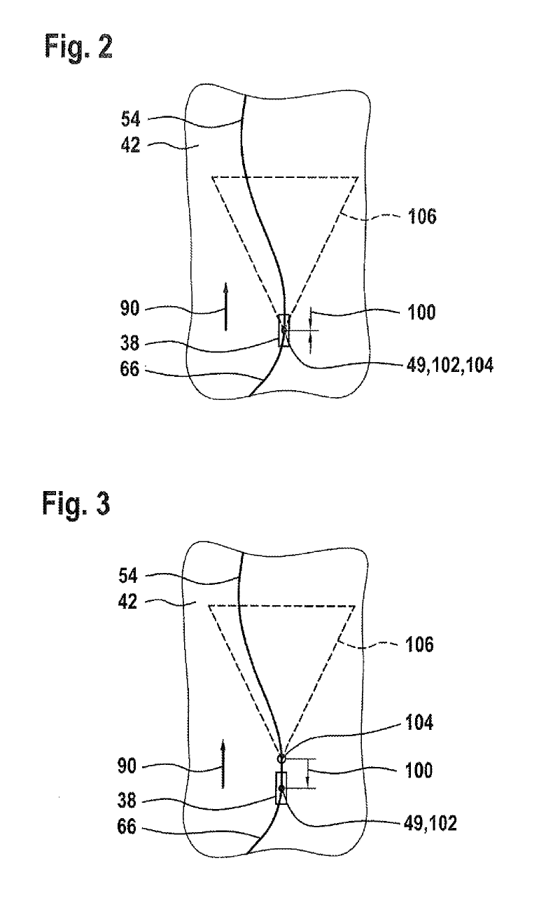

The distance 70 results in a positive or a negative offset between the point of origin of a digital processing, effected in the electronic control unit 26, and the rotation axis 49, or a rotation point, of the saw blade 38 (cf. FIGS. 2 to 3). The electronic control unit 26 is designed to electronically compensate the effect of the parallel distance 70 by displacing a respective point of origin of a digital (image) signal processing of the (image) signal 56 supplied by the assigned optoelectronic means 52, in that the offset is minimized, i.e. is brought as close as possible to the value zero.

The saw blade type, and therefore the parallel distance 70, are preferably sensed automatically by the electronic control unit 26, by means of the optoelectronic means 52, such that a user need not effect any further settings. Alternatively, the saw blade type can be input to the electronic control unit 26, for example by means of an input means 72 that can be easily and conveniently operated by the user, and to facilitate input the user may optionally be offered a selection comprising saw blades types that have been stored in advance in the electronic control unit 26. The electronic control unit 26 is then able automatically to determine and compensate the distance 70 on the basis of the selection input by the user. The input means 72 may be realized, for example, with a touch-sensitive screen, which is preferably positioned in the region of the handle 12 of the tool housing 14 of the jigsaw 10.

Furthermore, it is possible, additionally or alternatively, for a value for the distance 70 to be input to the electronic control unit 26 by the user. This may be effected, for example, by means of a control element 74, which is realized here, exemplarily, as a knurled wheel, and which, to facilitate operation, is preferably likewise disposed in the region of the handle 12 of the tool housing 14 of the jigsaw 10. In order to aid the setting process, a marking 76 may be disposed in the region of the foot plate 40.

The determination of the distance 70 for the respectively used saw blade type may be effected, moreover, by a sensor 78 positioned in an appropriate manner on or in the tool housing 14. For this purpose, the values determined by the sensor are transmitted by the latter to the electronic control unit 26 for further evaluation.

The determination of the current sawing speed, or the rate of advance of the jigsaw 10 in relation to the workpiece 42, which in many cases constitutes a further (contributory) cause of deviations between the ideal reference cutting line 54 and the kerf 66, may be determined by means of the optoelectronic means 52 and/or with the aid of a further sensor 80, and transmitted to the electronic control unit 26, likewise for further evaluation. The sensor 80 may be realized mechanically, e.g. by means of an encoder wheel rolling on the workpiece 42, or contactlessly, e.g. by means of an optical reflection measurement method.

FIG. 2 shows the workpiece 42 to be sawn by means of the saw blade of FIG. 1, a rotation axis, or a rotation point, of the saw blade 38 being identical with a point of origin of a signal processing. The saw blade 38 moves through the workpiece 42 at a defined sawing speed, in a sawing direction 90 along the reference cutting line 54, and thereby produces the kerf 66. An offset 100 between a rotation point 102, or the rotation axis 49, of the saw blade 38 and a point of origin 104 of a signal processing 106 of the signal supplied by the optoelectronic means 52 of FIG. 1 is zero in this case. As a result, the distance between the rotation axis 49, or the rotation point 102, of the saw blade 38 is compensated (electronically), such that an improved sawing result is obtained without appreciable deviations between the predefined reference cutting line 54 and the course of the kerf 66.

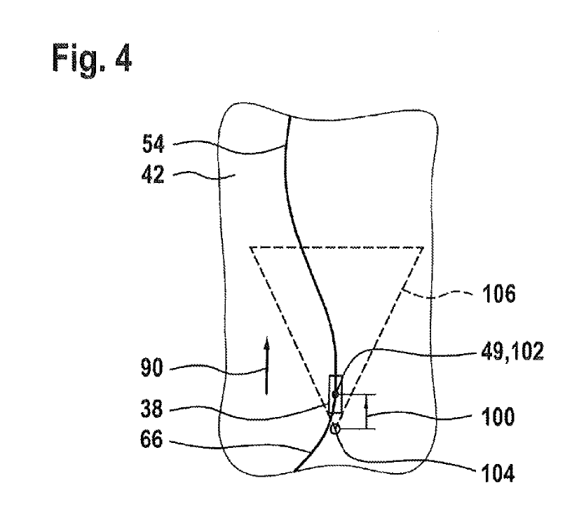

FIG. 3 and FIG. 4, to which reference is made jointly in the rest of the description, show a schematic top view of the workpiece 42 of FIG. 2, with a positive and a negative offset, respectively, between the rotation axis 49, or the rotation point 102, of the saw blade 38 and the point of origin of the signal processing 106 of FIG. 2. Unlike FIG. 2, in which the offset 100 is zero, in FIG. 3 a positive offset 100 is obtained, exemplarily, and in FIG. 4 a negative offset 100 is obtained, exemplarily. These may result in unwanted deviations between the reference cutting line 54 and the kerf 66 of FIG. 2, i.e. in sawing or cut errors.

The positive offset 100 in FIG. 3 can be compensated by shifting the point of origin 104 of the signal processing 106 contrary to the sawing direction 90, approximately as far as the rotation axis 49, or the rotation point 102, of the saw blade 38, by means of the electronic control unit 26 of FIG. 1. Correspondingly, the negative offset of FIG. 4 is compensated by shifting the point of origin 104 of the signal processing 106 in the sawing direction 90.

As a result of the point of origin 104 of the signal processing 106 being shifted in the direction of the rotation axis 49, or the rotation point 102, of the saw blade 38, the cut and sawing errors that occur as a result of the use of differing types of saw blade, each having a different parallel distance between the cutting edge and the rotation axis 49, can consequently be reduced, at least to a large extent.

Shown exemplarily in FIG. 5 are four differing saw blade types, or types of saw blade 120 to 126, each having a different distance between an assigned cutting edge and a rotation axis. Exemplarily, each of the saw blades 120 to 126 has a fastening portion 128, each being of the same type of design, within predefined tolerances, which can be accommodated and clamped in the universal tool holder 32 of the jigsaw 10 of FIG. 1. Generally, an optimum sawing result can only be achieved with a saw blade type, or saw blade, that is matched to the respective material of the workpiece on which work is to be performed, such that a plurality of saw blade types are necessary. Accordingly, the saw blade 120 is realized, exemplarily, as a ceramic saw blade, the saw blade 122 is realized, exemplarily, as a metal saw blade, the saw blade 124 is realized, for example, as a hardwood high-speed saw blade, and the saw blade 126 is realized, illustratively, as a normal (soft-) wood saw blade.

As additionally shown by FIG. 5, the saw blades 120 to 126 each have different distances between their respective cutting edges 132 their assigned rotation axes 134, all of these distances, however, being denoted by the reference 130 for reasons of simplicity. As explained above in the context of the description of FIG. 1 to FIG. 4, these distances 130, which depend on the respective saw blade type, must be compensated—in addition to a differing sawing speed, if appropriate—by the electronic control unit 26 of FIG. 1, in order to achieve a respectively desired working or sawing result, i.e. with least possible deviations between the reference cutting line 54 and the kerf, or the saw cut 66 of FIG. 1, by means of the jigsaw 10.

What is claimed is:

1. A hand-guided semiautonomous jigsaw, comprising:
a tool receiver configured to receive a saw blade that includes a cutting edge for sawing along a predefined reference cutting line on an assigned workpiece;
an assigned optoelectronic mechanism;
an electromechanical actuator mechanism that is configured to swivel the tool receiver within a predefined angular range about a swivel axis that is coincident with a rotation axis of the saw blade in response to a signal supplied by the assigned optoelectronic mechanism in order to automatically align the saw blade when sawing along the predefined reference cutting line; and
an electronic control unit configured to compensate a parallel distance between the cutting edge and the rotation axis of the saw blade during sawing.

2. The jigsaw according to claim 1, wherein the electronic control unit is further configured to compensate the parallel distance between the cutting edge and the rotation axis of the saw blade by shifting a respective point of origin of a signal processing of the signal supplied by the assigned optoelectronic mechanism.

3. The jigsaw according to claim 2, wherein the electronic control unit is further configured to shift the respective point of origin of the signal processing either in or contrary to a sawing direction.

4. The jigsaw according to claim 1, wherein the electronic control unit is further configured to compensate the parallel distance between the cutting edge and the rotation axis of the saw blade with reference to at least one of differing saw blade types and differing sawing speeds.

5. The jigsaw according to claim 4, wherein either:
the optoelectronic mechanism is configured to sense a respective saw blade type from amongst the differing saw blade types; or
an input mechanism is configured to receive a respective saw blade type from amongst the differing saw blade types as an input.

6. The jigsaw according to claim 1, wherein the tool receiver includes a fastening portion configured to accommodate the saw blade within the tool receiver, the fastening portion being configured and arranged so as to be symmetrical in relation to the rotation axis.

7. The jigsaw according to claim 1, wherein the optoelectronic mechanism is configured to sense at least the parallel distance.

8. The jigsaw according to claim 1, further comprising a sensor configured to sense at least the parallel distance.

9. The jigsaw according to claim 1, wherein the electronic control unit is further configured to store at least the parallel distance, and enable at least one of selection and confirmation by a user.

10. The jigsaw according to claim 1, further comprising a control element configured to enable a user to manually set the parallel distance.

11. The jigsaw according to claim 10, further comprising:
a foot plate; and
a marking, arranged in a region of the foot plate, for aiding the user in setting the parallel distance via the control element.

12. The jigsaw according to claim 1, wherein at least one of the optoelectronic mechanism and a sensor is configured to measure a respective sawing speed.

13. The jigsaw according to claim 1, wherein the jigsaw is configured such that, when in operation, in addition to executing the swivel about the swivel axis, the saw blade executes at least a vertically oscillating stroke motion.

14. A method of automatically aligning a saw blade of a hand-guided semiautonomous jigsaw, comprising:
arranging the saw blade within a tool receiver of the jigsaw such that a cutting edge of the saw blade is arranged for sawing along a predefined reference cutting line on an assigned workpiece;
supplying a signal via an assigned optoelectronic mechanism;
when sawing along the predefined reference cutting line, operating an electromechanical actuator mechanism, with reference to the signal, to swivel the tool receiver within a predefined angular range about a swivel axis that is coincident with a rotation axis of the saw blade in order to automatically align the saw blade; and
compensate a parallel distance between the cutting edge and the rotation axis of the saw blade using an electronic control unit.
